(19) United States
(12) Patent Application Publication
(10) Pub. No.: US 2023/0252363 A1
(43) Pub. Date: Aug. 10, 2023

(54) AUDIENCE MUSIC REQUESTER FOR LIVE MUSIC

(71) Applicant: James L Roth, Atlanta, GA (US)

(72) Inventor: James L Roth, Atlanta, GA (US)

(21) Appl. No.: 17/650,079

(22) Filed: Feb. 5, 2022

(51) Int. Cl. G06Q 10/02

(52) U.S. Cl. CPC G06Q 10/02

(57) ABSTRACT

A computer-implemented method for managing song requests from a patron to a band. A non-limiting example of the computer-implemented method includes receiving, by a processor, a request for a song from the patron; receiving, by the processor, a tip amount associated with the song; adding, by the processor, the song to a request queue; receiving, by the processor, an acceptance of the song; and initiating, by the processor, a transfer of the tip amount from an account associated with the patron to an account associated with the band.

### BACKGROUND

The present invention generally relates to music systems and more specifically, to an audience music requester for live performances.

Bands that play in clubs and bars often receive song or artist requests from their patrons. Bands often rely on tips from patrons in order to earn additional income. Usually the tips are received in connection with a request to play a particular song or a particular band. In order to make these requests, patrons typically approach the band and leave a note with a song request along with a tip before the band or make such a request verbally.

### SUMMARY

Embodiments of the present invention are directed to a computer-implemented method for managing song requests from a patron to a band. A non-limiting example of the computer-implemented method includes receiving, by a processor, a request for a song from the patron; receiving, by the processor, a tip amount associated with the song; adding, by the processor, the song to a request queue; receiving, by the processor, an acceptance of the song; and initiating, by the processor, a transfer of the tip amount from an account associated with the patron to an account associated with the band.

Embodiments of the present invention are directed to a system for managing song requests from a patron to a band. A non-limiting example of the system includes a processor and a memory communicatively coupled to the processor. The memory has stored therein instructions that when executed cause the processor to receive a request for a song from the patron; receive a tip amount associated with the song; add the song to a request queue; receive an acceptance of the song; and initiate a transfer of the tip amount from an account associated with the patron to an account associated with the band.

Embodiments of the invention are directed to a computer program product for for managing song requests from a patron to a band, the computer program product comprising a computer readable storage medium having program instructions embodied therewith. The program instructions are executable by a processor to cause the processor to perform a method. A non-limiting example of the method includes receiving, by a processor, a request for a song from the patron; receiving, by the processor, a tip amount associated with the song; adding, by the processor, the song to a request queue; receiving, by the processor, an acceptance of the song; and initiating, by the processor, a transfer of the tip amount from an account associated with the patron to an account associated with the band.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 depicts a high-level block diagram computer system, which can be used to implement one or more aspects of the present invention;

FIG. 4 depicts an environment for using a system in accordance with an embodiment of the present invention;

FIGS. 5-13 depict a patron user interface implementing a request method in accordance with an embodiment of the present invention;

FIGS. 14-19 depict a band user interface implementing a request method in accordance with an embodiment of the present invention;

FIG. 20 depicts a flowchart for receiving user requests in accordance with an embodiment of the present invention; and

FIG. 21 depicts a flowchart for managing user requests in accordance with an embodiment of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

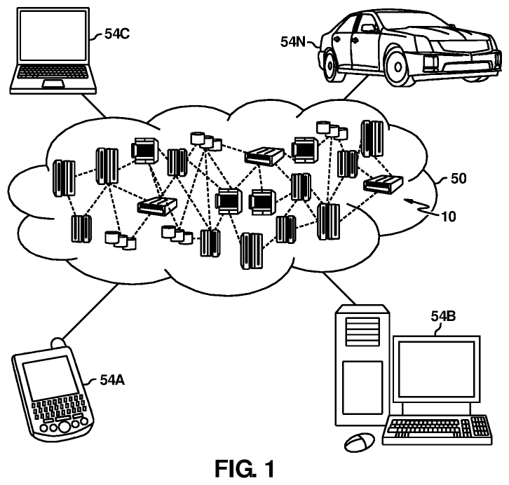

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

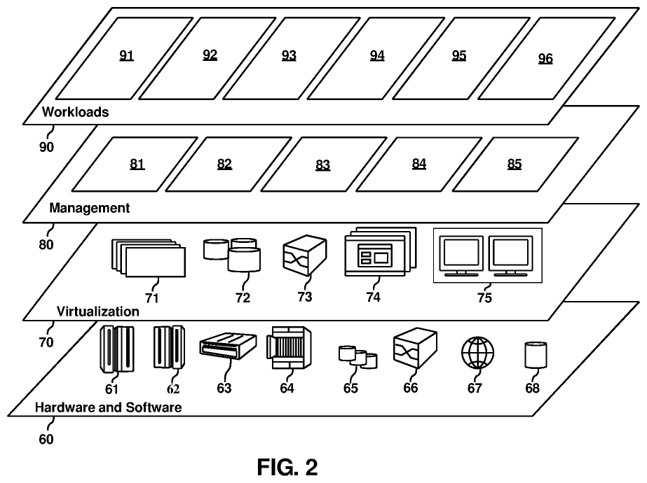

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; request reception processing 95; and request queue management processing 96.

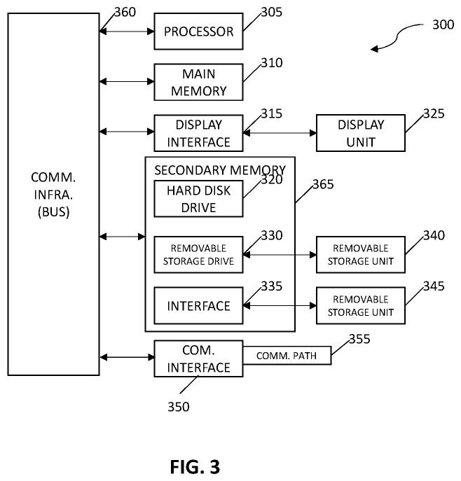

FIG. 3 depicts a high-level block diagram computer system 300, which can be used to implement one or more aspects of the present invention. More specifically, computer system 300 can be used to implement some hardware components of embodiments of the present invention. Although one exemplary computer system 300 is shown, computer system 300 includes a communication path 355, which connects computer system 300 to additional systems (not depicted) and can include one or more wide area networks (WANs) and/or local area networks (LANs) such as the Internet, intranet(s), and/or wireless communication network(s). Computer system 300 and additional system are in communication via communication path 355, e.g., to communicate data between them.

Computer system 300 includes one or more processors, such as processor 305. Processor 305 is connected to a communication infrastructure 360 (e.g., a communications bus, cross-over bar, or network). Computer system 300 can include a display interface 315 that forwards graphics, text, and other data from communication infrastructure 360 (or from a frame buffer not shown) for display on a display unit 325. Computer system 300 also includes a main memory 310, preferably random access memory (RAM), and can also include a secondary memory 365. Secondary memory 365 can include, for example, a hard disk drive 320 and/or a removable storage drive 330, representing, for example, a floppy disk drive, a magnetic tape drive, or an optical disk drive. Removable storage drive 330 reads from and/or writes to a removable storage unit 340 in a manner well known to those having ordinary skill in the art. Removable storage unit 340 represents, for example, a floppy disk, a compact disc, a magnetic tape, or an optical disk, etc. which is read by and written to by removable storage drive 330. As will be appreciated, removable storage unit 340 includes a computer readable medium having stored therein computer software and/or data.

In alternative embodiments, secondary memory 365 can include other similar means for allowing computer programs or other instructions to be loaded into the computer system. Such means can include, for example, a removable storage unit 345 and an interface 335. Examples of such means can include a program package and package interface (such as that found in video game devices), a removable memory chip (such as an EPROM, or PROM) and associated socket, and other removable storage units 345 and interfaces 335 which allow software and data to be transferred from the removable storage unit 345 to computer system 300.

Computer system 300 can also include a communications interface 350. Communications interface 350 allows software and data to be transferred between the computer system and external devices. Examples of communications interface 350 can include a modem, a network interface (such as an Ethernet card), a communications port, or a PCM-CIA slot and card, etcetera. Software and data transferred via communications interface 350 are in the form of signals which can be, for example, electronic, electromagnetic, optical, or other signals capable of being received by communications interface 350. These signals are provided to communications interface 350 via communication path (i.e., channel) 355. Communication path 355 carries signals and can be implemented using wire or cable, fiber optics, a phone line, a cellular phone link, an RF link, and/or other communications channels.

In the present description, the terms “computer program medium,” “computer usable medium,” and “computer readable medium” are used to generally refer to media such as main memory 310 and secondary memory 365, removable storage drive 330, and a hard disk installed in hard disk drive 320. Computer programs (also called computer control logic) are stored in main memory 310 and/or secondary memory 365. Computer programs can also be received via communications interface 350. Such computer programs, when run, enable the computer system to perform the features of the present invention as discussed herein. In particular, the computer programs, when run, enable processor 305 to perform the features of the computer system. Accordingly, such computer programs represent controllers of the computer system.

Turning now to an overview of technologies that are more specifically relevant to aspects of the invention, as previously stated, bands that play in clubs and bars frequently receive song or artist requests from their patrons. Bands often rely on tips from patrons in order to earn additional income. Usually the tips are received in connection with a request to play a particular song or a particular band. In order to make these requests, patrons typically approach the band and leave a note with a song request along with a tip before the band or make such a request verbally.

Unfortunately, this system of receiving song requests and tips has significant drawbacks. Patrons often do not have pens or paper slips available in order to write down their requests. Requests are frequently received scrawled on wet bar napkins, rendering them illegible. Furthermore, patron's handwriting may be affected by having taken in alcohol or other inebriants that leaves their handwriting difficult to read. In addition, more and more patrons rely on credit cards for payments and do not have readily available cash or, even if they have cash, they do not have bills of appropriate denomination. In addition, time is frequently wasted when patrons request songs that the band does not play, which leads to long spells of downtime as the patron and a band leader discuss potential alternative songs. Also, with the rising pandemic and fears of infectious disease, a measure of safety is missing in that close contact is required between the song requester and members of the band. Paper money, which may carry viruses and bacteria, is also a risk.

Furthermore, patrons who have requested songs have no idea when their song might get played, and, while it rarely happens, bands can forget that a patron has requested a particular song. As song requests are received haphazardly, it is difficult for the band to keep track of all of the songs that have been requested. In short, the currently used method is a failure.

Turning now to an overview of the aspects of the invention, one or more embodiments of the invention address the above-described shortcomings of the prior art by providing a method that facilitates patrons making song request. The method uses a combination of a patron's handheld device, typically a mobile phone or tablet, acting as a client in conjunction with a band's computing device, acting as a server, in order to receive song requests and tips from patrons. The method provides a patron the ability to directly request a particular song or a particular artist, along with an optional tip, and for that request to be received by the band. The band's computer receives the patron's request and tip amount in a request queue and can select that song to be added to an accepted queue. The patron can view the accepted queue on her device to see where her song is in the queue.

Additionally, the band can reorder the accepted queue at any time and can place a requested song anywhere in the queue at the time of acceptance. If the band is unwilling or unable to play a particular song or artist in the requested queue, the band may reject it, and a notice is sent to the patron that requested the song. Furthermore, because the patron is able to view the songs in the accepted queue, the patron can selected a song in the accepted queue and provide an additional tip, for example, if another patron had made the request and a patron would like to further tip the band for that song.

In addition, the band can maintain a database of songs and associated artists that it regularly plays. The patron is able to access this database and select a song or artist from the list to request. In this fashion, the patron knows what songs the band is confident in playing. The band can independently maintain this database, but also has the ability through the band's computer to add a song to its database from the accepted queue or the requested queue. In this way, the band can organically grow its database of songs.

By using electronic transfer of funds and requests, a measure of safety is added because requests can be made at a distance. In addition, paper money that may carry disease is avoided.

The above-described aspects of the invention address the shortcomings of the prior art by providing a method that is far superior to the random, haphazard method in place today. Furthermore, by implementing the method on a computer system, the method is able to track a huge database of songs and artists and can track statistics on song requests and associated tips. Also, by automating the method, the method can associate songs with a database of music and lyrics that can be presented on the band computer, or another computer, in order to facilitate performance.

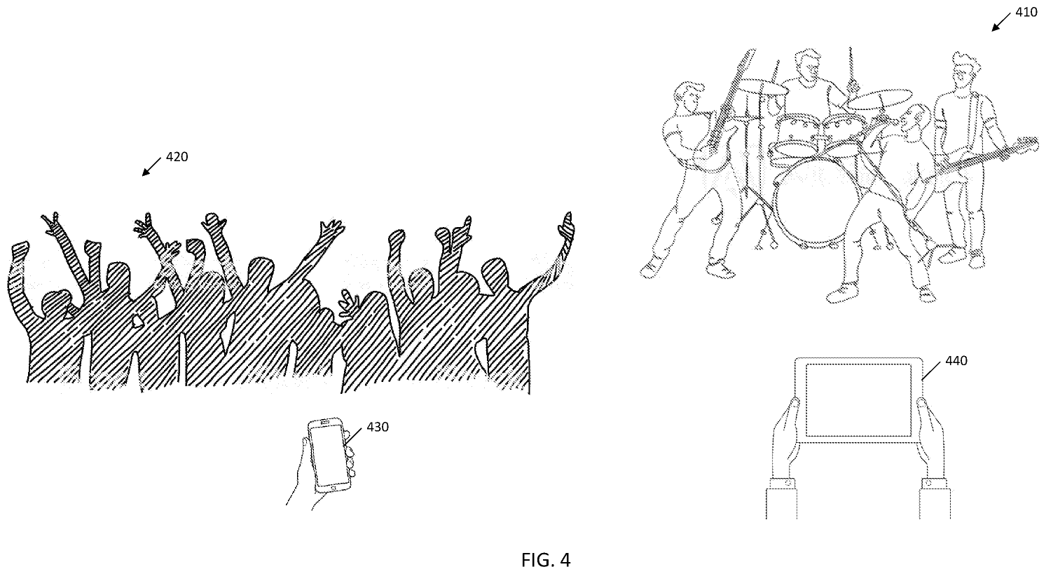

Turning now to a more detailed description of aspects of the present invention, FIG. 4 depicts an environment for using a system in accordance with an embodiment of the present invention. In a typical club or bar environment, a band 410 plays before a group of patrons 420. One or more patrons possesses a patron device 430, that may be, for example, a tablet computer or smartphone. The patron device 430 is in communication with a band device 440 that is typically a tablet computer, but could be a smartphone, a portable computer, or a desktop computer. The patron device 430 typically communicates with the band device 440 over Wifi, Bluetooth, 4G mobile, or 5G mobile. The patron device 430 and band device 440 is a computer system 300 as described in FIG. 3 or as described in hardware and software layer 60 in FIG. 2. The band device 440 may be a unit owned by the band or one provided by the club or bar.

Not shown, but also available is a video monitor viewable by a plurality of patrons and/or the band. The video monitor may display a logo and songs that have been accepted for play and present in a queue.

In addition, venues, such as bars or clubs, may provide a list of schedules of upcoming bands that are stored in a central database and accessible by patrons on patron device's 430. A patron may search for a venue, a band, or a neighborhood to find venues and/or bands that they may want to hear perform.

The system also supports a post-gig messaging feature that permits artists to message tipping patrons from the most recent performance. For example, the band may message all or a subset of patrons with the message, “Thank you for your support. We will be playing at the Fuzzy Navel next Saturday. We look forward to seeing you there.”

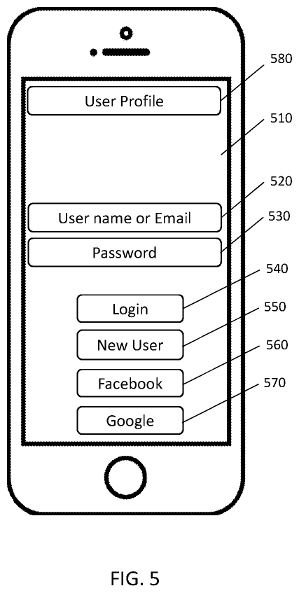

FIGS. 5-13 depict a patron user interface implementing the request method in accordance with an embodiment of the present invention. FIG. 5 depicts a login screen 510 of the patron user interface implementing the request method in accordance with an embodiment of the present invention. A patron may enter his user name or email in user name entry field 520, along with a password in password entry field 530. Afterward, the patron may hit a login button 540, and processor 305, will access database, such as database 68, in order to verify the user name and login information and provide location information to the requester system. In an alternative embodiment, a patron may login with Facebook via Facebook login button 560 or with Google via Google login button 570.

If the patron is a new user, or the user name received is not recognized, the requester system, through processor 305, will provide the patron with a new user interface (not shown) where a user can enter her name and email, along with a password, to create a new user account on the requester system. From this new user interface, the patron may also link her account to a PayPal, other electronic payment system, or a credit or charge card. For example, the patron may link their account with an Apple Pay account. The user may also access his information and payment information from login screen 510 though a user profile button 580.

After a user logs in to the system, processor 305, will access a locale database, such as can be stored in database 68, to determine a band in the same locale with which to associate. In the alternative, upon bringing up the login screen, the requester system via processor 305 will scan any wifi networks to which it is connected to see if there is a band device 440 present on the same network as the patron device 430. If so, the patron device 430 becomes linked to the band device 440.

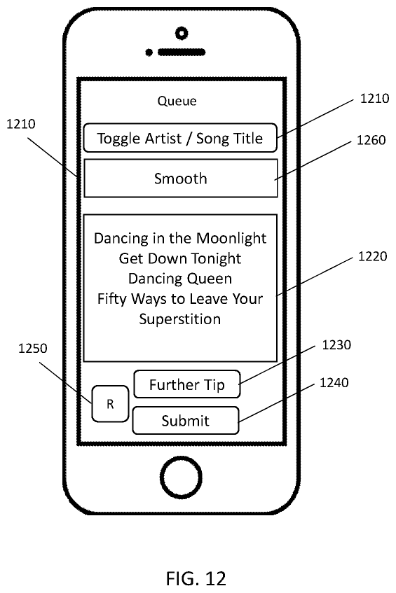

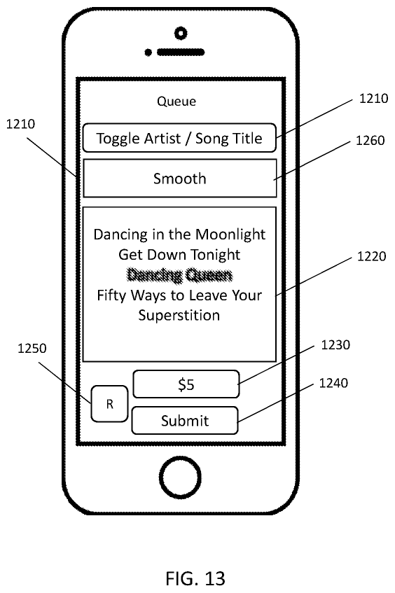

Also present is queue button 680 which will bring up a screen displaying a queue of accepted music, as will be described below with respect to FIGS. 12 and 13.

While the requester system has been and will be described with respect to the hardware and software of FIG. 3, those skilled in the art after reading this disclosure will appreciate that the cloud based system of FIG. 2 could also be used to implement the requester system. Furthermore, reference is made to database 68 of FIG. 2, but this database can also be present on band device 440.

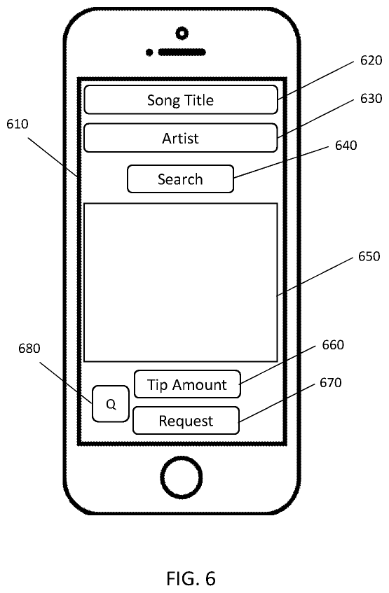

FIG. 6 depicts a patron request screen 610 of the patron user interface implementing the request method in accordance with an embodiment of the present invention. Patron request screen 610 provides an entry field for a song title entry field 620 and an entry field for an artist title entry field 630. Also provided is a tip amount entry field 660. A patron may enter either a song title in song title entry field 620 or an artist title in artist title entry field 630, along with an optional tip in tip amount entry field 660, and hit a request button 670. After hitting the request button 670, processor 305 provides the entered information to the band device 440 which will add the song or artist entered to a requested queue on the band device 440. In alternative embodiments of the invention, when text is entered into song title entry field 620 then no text is permitted to be entered into artist entry field 630 and vice-versa. There can also be an additional field (not shown) into which a patron may enter a message along with the song request. For example, the message may be “It's Jane's birthday!”

A similar screen may also be presented to a patron on the patron device 430 that permits the patron to tip the band and that is not associated with any particular music request.

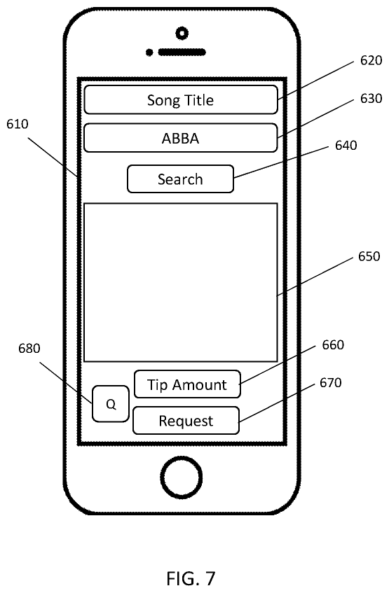

In addition, if a patron wants to see a list of songs or artists in the band's database of available songs, the patron may enter a song title, or portion of a song title with or without wild card characters, into song title entry field 620 and hit the search button 640. Upon hitting the search button 640, processor 305 will access database 68 to retrieve all matching songs from the band's database of songs, with the results displayed in song window 650. The same can be performed for artist, as will be described below with respect to FIGS. 7, 8, and 9.

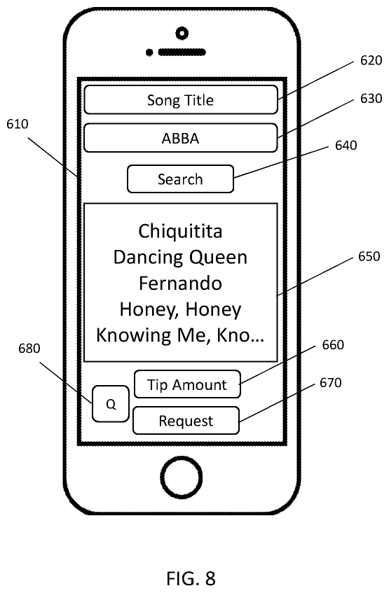

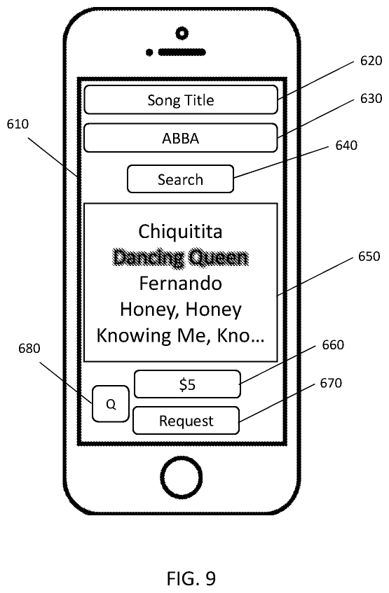

FIG. 7 depicts a patron request screen 610 of the patron user interface implementing the request method in accordance with an embodiment of the present invention. In this figure, a patron has entered artist title “ABBA” in the artist entry field 630. The patron hits the search button 640 which initiates a search for songs by the artist “ABBA” in database 68. In FIG. 8, a list of songs by “ABBA” appears in song window 650 and is presented, by processor 305, to the patron. As shown in FIG. 9, the patron may select a song from song window 650 (in this case “Dancing Queen”), optionally enter a tip in tip entry field 660, and hit the request button 670 to request the song. Processor 305 will then send the song request along with any tip amount to band device 440.

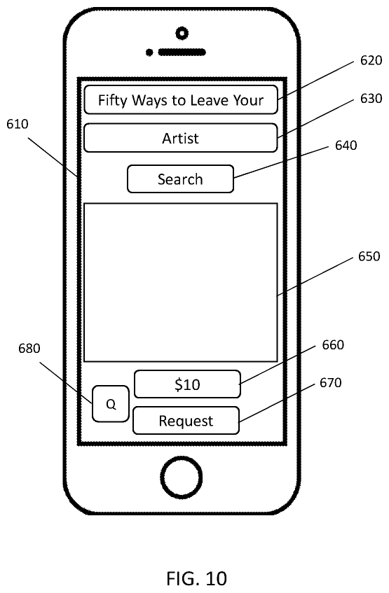

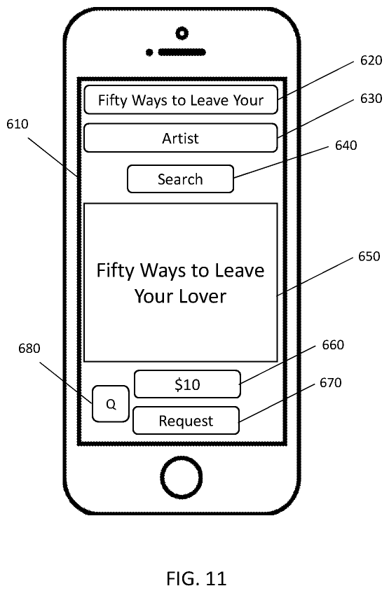

FIGS. 10 and 11 depict a similar search being done for a song from the database 68 maintained by the band device 440. In FIG. 10, the patron has entered “Fifty Ways to Leave Your” into song entry field 620, along with a tip of $10 in tip entry field 660, and hits the search button 640. The processor 305 searches database 68 for a matching song and returns, in FIG. 11, Fifty Ways to Leave Your Lover, in song window 650, which the patron may select and request with request button 670. As previously stated, the patron may use wild cards in place of characters in either the song entry field 620 or the artist entry field 630.

Hitting the Q button 680 at any time, will bring up the queue of accepted songs retrieved from the band device 440 by processor 305. FIG. 12 depicts the Queue screen 1210 implementing the request method in accordance with an embodiment of the invention. A queued song display 1220 displays a list of songs in the accepted song queue retrieved from the band device 440 by processor 305. In addition, the song being currently performed in provided in now playing field 1260. A toggle button 1210 toggles, using processor 305, the queued song display 1220 between displaying song name and artist name. A return button 1250 returns to the patron request screen 610. A further tip entry field 1230 permits entry of an additional tip for a song that is displayed and selected in the song display 1220. Hitting the submit button 1240 will submit the additional tip to the band device 440. A cancel button (not shown) permits a patron to cancel a song from the queue that she previously requested.

For example, FIG. 13 depicts the Queue screen 1210 with a song selection and a further tip entry implementing the request method in accordance with an embodiment of the invention. In this case, the patron has selected “Dancing Queen” for a further tip of five dollars. Upon hitting submit button 1240, the five dollar tip is submitted to the band device and associated with the song “Dancing Queen.”

A social causes screen (not shown) may also be present that permits a patron to donate to a special cause selected by the band. This may be done during or after a performance.

Additionally, the system may feature a social media and reward aspect where patrons at an event may send out text messages to the group of patrons at the event. Also, patrons may get reward points for requesting songs and providing tips. The biggest tipper in a region or city, for example, may be given a title, such as “The Catfish,” for her generous support of live music in the region. Lists of tippers and points may be provided to patrons, while a patron can opt out of being displayed on such a screen.

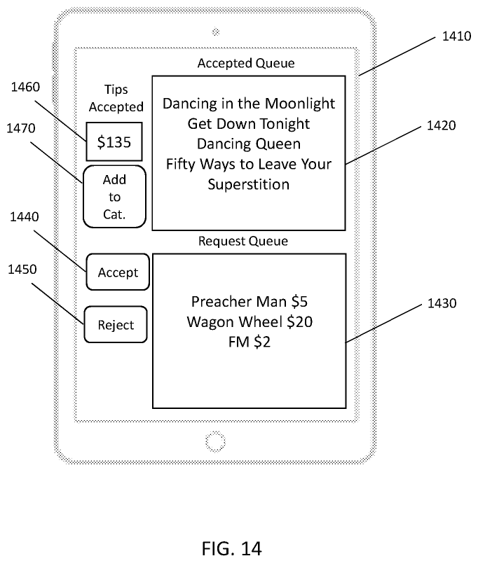

FIGS. 14-19 depict a band user interface 1410 implementing the request method in accordance with an embodiment of the present invention. The band user interface 1410 presents a request queue 1430 and an accepted queue 1420. The request queue, maintained by processor 305, is a list of requests received by band device 440 from one or more patron devices 430, along with any associated tip. The accepted queue 1420, maintained by processor 305, displays a list of songs that have been accepted by the band at band device 440 and, optionally, also displays the tip associated with the song. An accept button 1440 accepts one or more songs selected in request queue 1430. Hitting the accept button 1440 will move the selected song or songs to accepted queue 1420, and, optionally, will send a notification to the patron that requested the song. A reject button 1450 rejects one or more selected songs in request queue 1430, removes the song from request queue 1430, and sends a polite notification the patron that sent the request that the band is unable to perform the song.

A tips accepted field 1460 displays a running total of tips for songs accepted during the course of the current performance. An add to catalog button 1470 operates in conjunction with a selection of a song in either the request queue 1430 or the accepted queue 1420 to add the selected song or songs to the database 68 of music performed by the band.

In one embodiment, tips are received, and money transferred from the patron's registered account to a band's account, upon the song being accepted from the request queue 1430. In an alternative environment, the tip is received and money transferred from the patron's registered account to a band's account upon reaching the top of the accepted queue when it is played. The band may make a special motion, such as a swipe or double tap, to indicate that a song is being played. In an alternative embodiment, an additional button may be present that may be pressed along with a song selection to indicate that a song is being played.

In another embodiment, tips are received by a third party who then disperses all or a portion of the tips to the band. The tips can be sent to a single individual or can be divided up and sent directly to each member of the band. Members of the band may go through a check-in function to let the system know that they are present and in the band. The system or a band leader may allocate what percentage of the tips go to each band member. So, for example, the drummer may receive 30%, lead guitar 30%, bass guitar 30%, keyboard player 5%, and singer 5%.

If a patron adds to a tip for a song currently in the accepted queue 1410, the display may display a notification to the band, and, if the tip amount is also displayed in accepted queue 1420 then the tip amount is increased by the additional amount.

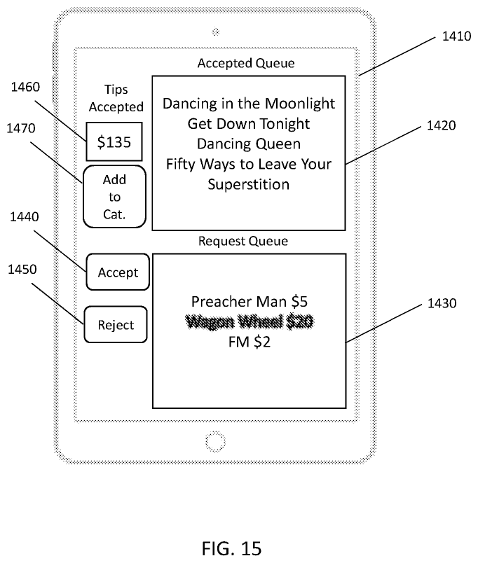

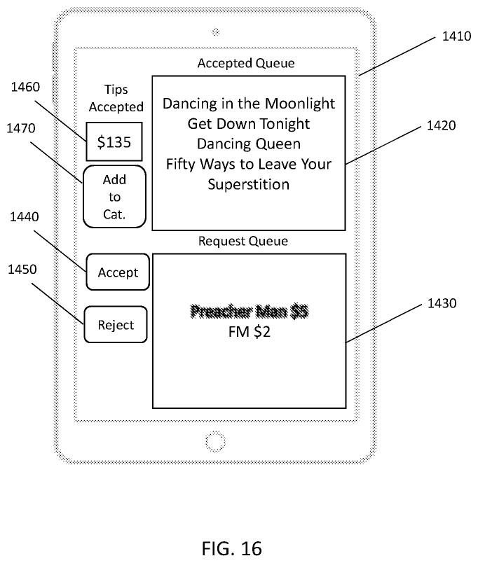

In FIG. 15, the band has selected the song “Wagon Wheel” having a $20 tip associated with it, and hits reject button 1450. Following that action, FIG. 16 indicates that “Wagon Wheel” has been removed from the request queue 1430. Also in this figure, the band has selected the song “Preacher Man” from the request queue 1430 and hits the accept button 1440.

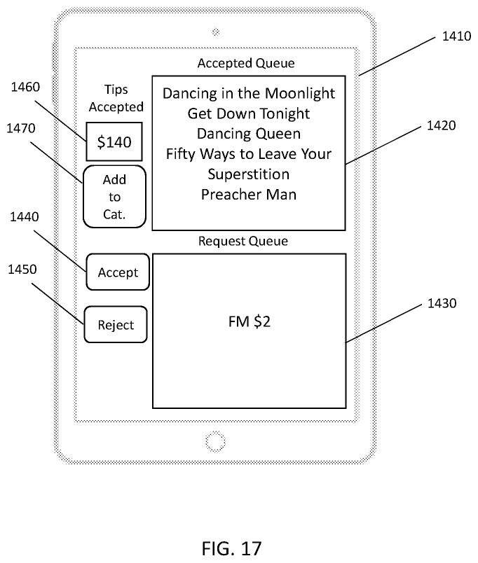

Upon hitting the accept button 1440, FIG. 17 depicts “Preacher Man” removed from the request queue 1430 and placed in the accepted queue 1420. In addition, the tips accepted field is incremented by five dollars to indicate that the song has been accepted, and a notification may be sent to the patron that requested song “Preacher Man” has been accepted.

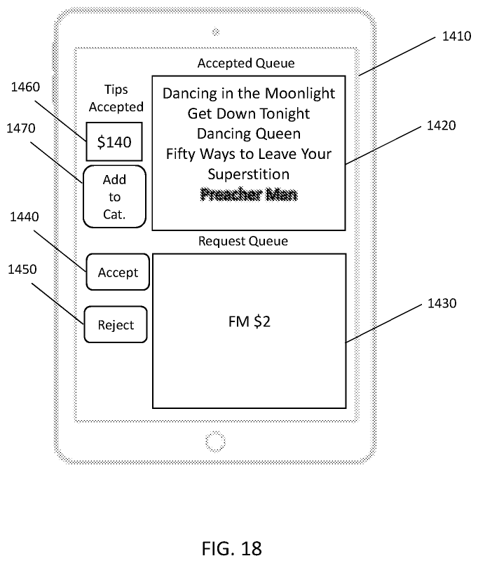

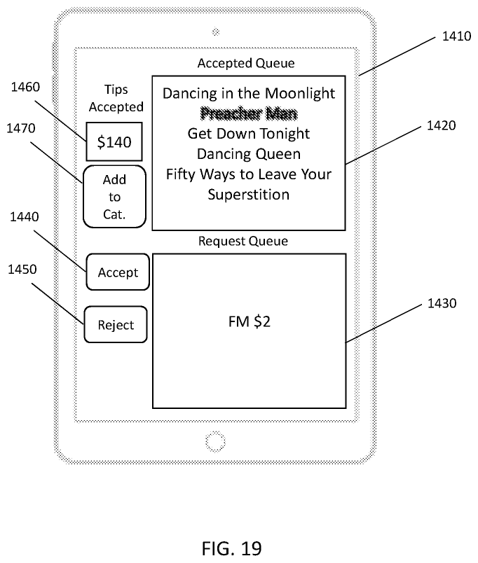

FIGS. 18 and 19 depict the band moving a song from one place in the accepted queue to another place in the accepted queue. In FIG. 18, the band selects “Preacher Man” and drags it up in the accepted queue, until, as shown in FIG. 19, the song “Preacher Man” appears after “Dancing in the Moonlight.”

Additionally, the band device 440 can have a feature permitting the band to enter and record cash tips and song requests that they receive, placing the song requests into the accepted queue.

The band device 440 can also have a feature permitting a band member to review a history of songs requested and a history of songs requested. The histories may be sorted by total or average tips received, so that a band can know which songs are the most valuable, potentially opting to only play them when requested.

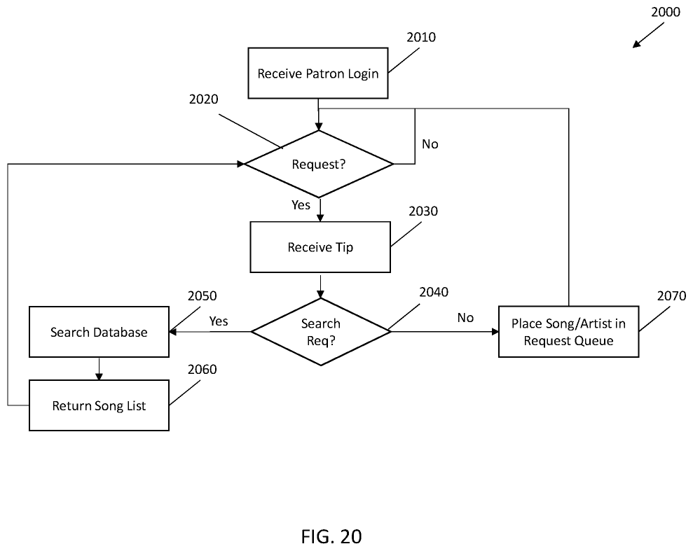

FIG. 20 depicts a flowchart for receiving user requests in accordance with an embodiment of the present invention. The method 2000, using processor 305, receives patron login information (stage 2010). It verifies the user login information against what is stored for users in database 68, and, once the user is verified, proceeds to stage 2020. If the patron is not verified, for example, it is a new patron, the patron will be prompted by processor 305 to create an account and optionally enter payment information as previously described. After this, flow continues to stage 2020.

The processor 305 waits on a user to make a request for a song or an artist or for a search request (stage 2020). When a request is received, any tips entered by the patron are also received (stage 2030). If the request is a search request (stage 2040), the database 68 is searched by processor 305 for songs or artists matching a patron's search query (stage 2050). The list of songs returned by the request is provided to the patron (stage 2060) and flow returns to stage 2020. If the request is not a search request (stage 2040), but rather a specific song or artist, processor 305 places the song or artist in the request queue (stage 2070).

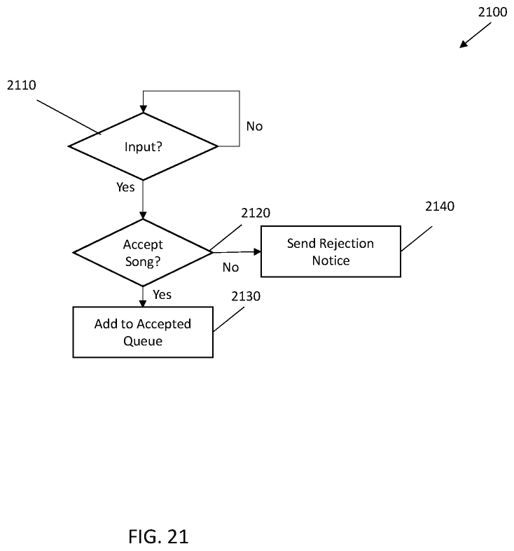

FIG. 21 depicts a flowchart for managing user requests in accordance with an embodiment of the present invention. The processor 305 waits for input from the band (stage 2110). If input is received (stage 2110), the processor 305 checks to see if a song has been accepted by the band (stage 2120). If so, the song is added to the accepted queue and removed from the request queue by processor 305 (stage 2130). If the song is rejected, a rejection notice may be sent to the patron that requested the song and the song is removed from the requested queue (stage 2140). In practice, method 2100 performs these various checks and functions in parallel, such that it is looking for song acceptance or rejection simultaneously with other functions. For example, while not specifically illustrated, method 2100 awaits song or artist requests from a patron device 430, and when received places the song or artist in the request queue. In addition, method 2100 awaits song or artist search requests and searches database 68 to return matching songs or artists, as appropriate.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for managing song requests from a patron to a band, comprising:
receiving, by a processor, a request for a song from the patron;
receiving, by the processor, a tip amount associated with the song;
adding, by the processor, the song to a request queue;
receiving, by the processor, an acceptance of the song; and
initiating, by the processor, a transfer of the tip amount from an account associated with the patron to an account associated with the band.

2. The computer-implemented method of claim 1 further comprising, upon an acceptance of the song, removing, by the processor, the song from the request queue and placing the song in an acceptance queue.

3. The computer-implemented method of claim 2 further comprising receiving, by the processor, an additional tip associated with the song from a second patron.

4. The computer-implemented method of claim 1 further comprising providing, by the processor, a notification to the patron upon acceptance of the song.

5. The computer-implemented method of claim 1 further comprising:
receiving, by the processor a request for a second song from the patron;
adding, by the processor, the request for the second song to the request queue; and
receiving, by the processor, a rejection of the second song.

6. The computer-implemented method of claim 5 further comprising removing, by the processor, the second song from the request queue.

7. The computer-implemented method of claim 5 further comprising sending, by the processor, a notification of rejection of the second song to the patron.

8. A system comprising:
a processor;
a memory communicatively coupled to the processor, the memory having stored therein instructions that when executed cause the processor to:
receive a request for a song from the patron;
receive a tip amount associated with the song;
add the song to a request queue;
receive an acceptance of the song; and
initiate a transfer of the tip amount from an account associated with the patron to an account associated with the band.

9. The system of claim 8 further comprising instructions that when executed cause the processor to, upon an acceptance of the song, remove the song from the request queue and placing the song in an acceptance queue.

10. The system of claim 9 further comprising instructions that when executed cause the processor to receive an additional tip associated with the song from a second patron.

11. The system of claim 8 further comprising instructions that when executed cause the processor to provide a notification to the patron upon acceptance of the song.

12. The system of claim 8 further comprising instructions that when executed cause the processor to:
receive a request for a second song from the patron;
add the request for the second song to the request queue; and
receive a rejection of the second song.

13. The system of claim 12 further comprising removing, by the processor, the second song from the request queue.

14. The system of claim 12 further comprising instructions that when executed cause the processor to send a notification of rejection of the second song to the patron.

15. A computer program product for managing song requests from a patron to a band, the computer program product comprising a computer readable storage medium having program instructions embodied therewith, the program instructions executable by a processor to cause the processor to:
receive a request for a song from the patron;
receive a tip amount associated with the song;
add the song to a request queue;
receive an acceptance of the song; and
initiate a transfer of the tip amount from an account associated with the patron to an account associated with the band.

16. The computer program product of claim 15 further comprising instructions that when executed cause the processor to, upon an acceptance of the song, remove the song from the request queue and placing the song in an acceptance queue.

17. The computer program product of claim 16 further comprising instructions that when executed cause the processor to receive an additional tip associated with the song from a second patron.

18. The computer program product of claim 15 further comprising instructions that when executed cause the processor to provide a notification to the patron upon acceptance of the song.

19. The computer program product of claim 15 further comprising instructions that when executed cause the processor to:
receive a request for a second song from the patron;
add the request for the second song to the request queue; and
receive a rejection of the second song.

20. The computer program product of claim 19 further comprising removing, by the processor, the second song from the request queue.
